(19) United States
(12) Patent Application Publication
(10) Pub. No.: US 2013/0271464 A1
(43) Pub. Date: Oct. 17, 2013

(54) Image Generation with Multi Resolution

(71) Applicant: Klaus Engel, Nurnberg (DE)

(72) Inventor: Klaus Engel, Nurnberg (DE)

(21) Appl. No.: 13/860,497

(22) Filed: Apr. 10, 2013

(30) Foreign Application Priority Data
Apr. 11, 2012 (DE) DE 102012205847.8

(51) Int. Cl. G06T 15/08; G06T 15/06

(52) U.S. Cl. CPC G06T 15/08; G06T 15/06
USPC 345/426; 345/419

(57) ABSTRACT

A method for generating an image formed with pixels from volume data representing a volume with the aid of volume rendering with multi resolution is provided. The method includes implementing a calculation of a pixel of the image and determining an item of information characterizing resolution used during the pixel calculation. The method also includes adjusting the pixel in accordance with the item of information.

This application claims the benefit of DE 10 2012 205 847.8, filed on Apr. 11, 2012, which is hereby incorporated by reference.

### BACKGROUND

The present embodiments relate to a method, an apparatus and a computer program for generating an image formed with pixels from volume data representing a volume with the aid of volume rendering with multi resolution.

The visualization of three-dimensional data or volumes may be provided by generating an image for rendering using monitors or displays. In this process, the volume may be expressed by voxels, and the image may be expressed by pixels. In this way, voxels assign values of a variable to spatial points. For example, in the case of medical imaging methods, these variables represent a measure of the density of the volume at the corresponding voxel. By contrast, the pixels form a two-dimensional array or a two-dimensional matrix that includes the information relating to the volume for presentation on a display.

For display purposes, voxels (e.g., defined in three dimensions) are mapped onto pixels (e.g., defined in two dimensions). This mapping may be referred to as volume rendering. How information contained in the voxels is reproduced by the pixels (e.g., the direction and resolution of the display) depends on the implementation of the volume rendering.

One of the most used volume rendering methods is the ray casting method and/or the simulation of incident light for displaying and/or visualizing the body (cf. Levoy “Display of Surfaces from Volume Data”, IEEE Computer Graphics and Applications, Edition 8, No. 3, May 1988, pages 29-37). With ray casting, simulated beams that emanate from the eyes of an imaginary observer are sent through the examined body and/or the examined object. RGBA values from the voxels are determined along the beams for scanning points and are combined at pixels for a two-dimensional image using Alpha Compositing or Alpha Blending. The letters R, G and B in the expression RGBA stand for the color components red, green and blue, from which the color contribution of the corresponding scanning point is composed. A stands for the ALPHA value, which represents a measure of the transparency at the scanning point. The respective transparency is used when overlaying RGB values at the scanning points relative to the pixel. Illumination effects may be taken into account using an illumination model within the scope of a method referred to with “shading”.

A primary technical obstacle in implementation of a system for interactive volume rendering is the rapid, efficient and local processing of large quantities of data. With modem medical imaging facilities, the data quantities acquired are very significant. For example, with the Siemens Somatom Sensation 64 CT scanner, which may acquire slices 0.33 mm thick, more than five thousand slices may be used, for example, for a complete body scan. With the industrial use of computer tomography devices, the data quantities to be processed may be even more significant. This is as a result of the limitations in terms of medical use being dispensed with for the x-ray dose, and as a result of the combination of several scans, which may be provided.

One approach to solving this problem is the use of a client-server architecture in conjunction with multi resolution. A high-power computer with a significant storage and processing power is used as a server. Data at the server is transmitted via a network to a client machine (e.g., a client PC) in order to display an image generated by volume rendering at the client machine. A computer without sufficient processing power (e.g., a conventional PC or laptop) is to be useable as a client machine. On account of necessary updates or recalculations when manipulating the image via the client machine, the required computing effort and the data quantities to be transmitted may be kept within limits. Methods with multi resolution are used for this purpose. A multi resolution method may also be provided as a purely client-side solution. The data is stored on a hard disk/SSD or a network drive and is streamed into a relatively small main/GPU memory. The concept may also be used effectively on notebooks with a midrange configuration.

A method of this type is described, for example, in the publication “Interactive GigaVoxels” by Cyril Crassin, Fabrice Neyret and Sylvain Lefebvre, Technical Report, INRIA Technical Report, June 2008. A tree structure is used. The leaves of the tree structure are assigned to tiles. The tiles of all leaves cover the entire volume. A brick or a constant value is assigned in each instance to the leaves. The brick includes a fixed number of voxels characterizing the tile (e.g., M³ with=16). A constant value is predetermined if the corresponding tile does not contribute to the pixel calculation (e.g., with complete coverage of the corresponding volume).

Different resolution stages are achieved by bricks including the same number of voxels irrespective of the depth of the associated leaf. When passing through a leaf that does not reach the required resolution stage (e.g., level of detail (LOD)), further nodes derived from the nodes, which assume the function of leaves from the original leaves, are formed. The required data is then loaded in order to assign the corresponding bricks to the new leaves. Therefore, eight derived nodes (e.g., child nodes) are formed, for example, for an N³-tree with N=2 and/or for an octree. Instead of the original M³ voxel, the resolution would be refined to 8*M³ voxel (in 8 tiles).

With methods for multi resolution, the image may be calculated with a correspondingly higher or lower resolution in accordance with the existing resources. This refers to the data resolution (e.g., the accuracy of the calculation of individual pixels and not image resolution; the number of pixels used to display the image).

### SUMMARY AND DESCRIPTION

The present embodiments may obviate one or more of the drawbacks or limitations in the related art. For example, image interpretation or image analysis in an image is improved using volume rendering with multi resolution.

The procedure enables the provision of information concerning the resolution, with which pixels of the image were calculated, in the generation of an image from voxels and/or volume data formed with pixels. The volume data represents a volume or object to be represented. The volume data may be expressed, for example, by gray-scale values at spatial points within the volume. The gray-scale values may correspond in medical imaging methods to density values at the corresponding locations obtained from measured data using reconstruction. The measured data may have been recorded by a medical modality (e.g., magnetic resonance tomography, computed tomography, x-ray apparatus, ultrasound device). Alternatively, the measured data may also originate from material and/or work piece examinations.

Volume rendering with multi resolution takes place in order to calculate image pixels. Information that characterizes a resolution used during pixel calculation is determined. For example, the calculation is implemented with a number of different resolutions. The information identifies the resolution used. A distinction as to whether the calculation was implemented with a target resolution (e.g., the highest resolution) or another resolution may be made using the information. For example, an adjustment is made if the target resolution was used. In one embodiment, at least one pixel is adjusted in accordance with the information (e.g., the adjustment may still depend on further parameters such as the resolution with which other pixels of a common block have been calculated). The adjustment includes, for example, tinting, shading, selecting a rendering mode, selecting a modulation mode or a combination thereof. The corresponding pixel is shown differently by the adjustment (e.g., the user receives visual information about the resolution used during the calculation via one of the displays of the image). The adjustment may take place both during the course of the pixel calculation and also subsequent thereto.

A volume rendering takes place, for example, using ray casting or simulated beams. Scanning values are calculated along the beam during ray casting. An adjustment may take place per scanning value, per beam or also per beam block. An adjustment per scanning value may result in a pixel adjustment, since the pixel results from the combination (e.g., compositing) of associated pixel values. For each scanning value, for example, it is determined whether the scanning value would change with the target resolution and, if necessary, the transfer function. A realization of an adjustment per beam may use a flag, for example, that is set if a scanning value was not calculated with the target resolution. According to the flag (e.g., as the information characterizing the resolution used), a tinting of the calculated pixel takes place, for example. In one embodiment, blocks of beams may be combined, and a change may take place if all pixels of the block were calculated with a target resolution. A summary in blocks may result in a more uniform and improved image to be recorded. Depending on the procedure in terms of pixel calculation, a non-uniform, optically not easily identifiable pattern, which may be prevented by a treatment per block, may result.

In one embodiment, pixels not calculated with a target resolution are recalculated. The user may thus understand which parts of the image (e.g., which is updated during the course of pixel recalculations) already exist with target resolution and which parts of the image do not already exist with target resolution. The working efficiency in the image evaluation and the workflow are improved, since the user may initially concentrate on parts of the image that already represent details with a high resolution.

An apparatus and a computer program for generating an image including volume data representing a volume formed with pixels with the aid of volume rendering with multi resolution are also provided. The apparatus includes a computing unit for implementing calculation of a pixel of the image. The apparatus is embodied so as to determine information characterizing a resolution used during the pixel calculation and to adjust the pixel in accordance with this item of information.

### BRIEF DESCRIPTION OF THE DRAWINGS

FIG. 1 shows a schematic representation in the z-direction of one embodiment of a spiral CT device including a number of rows of detector elements;

FIG. 2 shows a longitudinal section along the z-axis through the device according to FIG. 1;

FIG. 3 shows a schematic image to illustrate an exemplary process of a ray casting method;

FIG. 4 shows a flow chart of one embodiment of a rendering; and

FIGS. 5-8 show exemplary calculated, increasingly refined images.

### DETAILED DESCRIPTION OF THE DRAWINGS

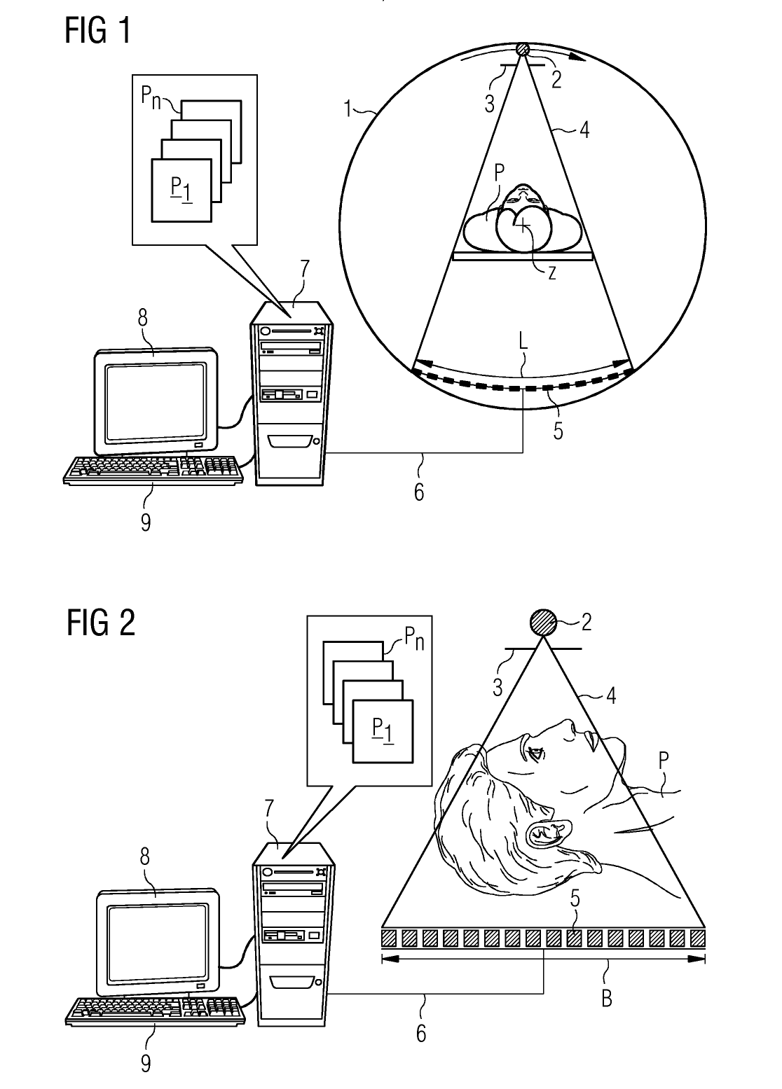

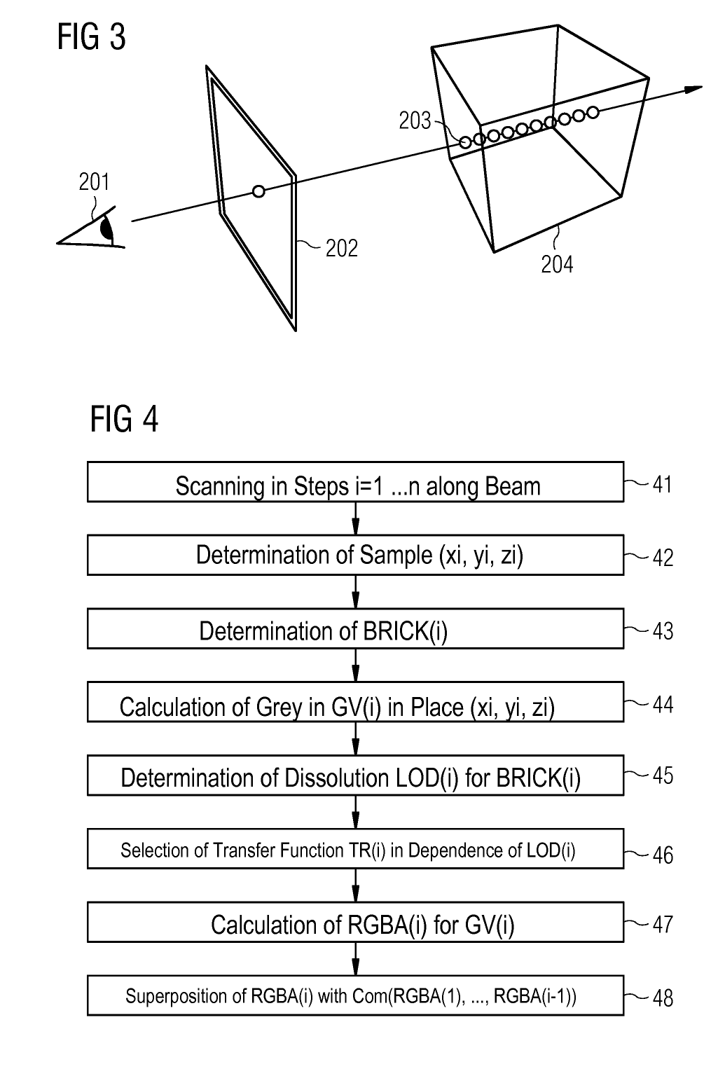

A spiral CT device with a multirow detector is shown in FIGS. 1 and 2. FIG. 1 shows a schematic representation of a gantry 1 having a focus 2 and a similarly rotating detector 5 (e.g., with width B and length L) in a section perpendicular to the z-axis, while FIG. 2 shows a longitudinal section in the direction of the z-axis. The gantry 1 has an x-ray beam source with the focus 2 shown schematically and a beam diaphragm 3 close to the x-ray beam source and arranged upstream of the focus 2. A beam bundle 3 proceeds from the focus 2, limited by the beam diaphragm 3, to an opposite detector 5, penetrating the patient P disposed therebetween. The scanning takes place during the rotation of the focus 2 and the detector 5 about the z-axis. The patient P is simultaneously moved in the direction of the z-axis. A spiral path S for the focus 2 and the detector 5 appears in this way in the coordinate system of the patient P having a gradient or advance B, as shown spatially and schematically in FIG. 3.

When the patient P is being scanned, dose-dependent signals acquired by the detector 5 are transmitted to the computing unit 7 via data/control line 6. With the aid of known methods that are stored in program modules P₁ to Pₙ, the spatial structure of the scanned area of the patient P with respect to absorption values of the patient P is calculated or reconstructed (e.g., a filtered back projection (FBP) method, a Feldkamp algorithm, an iterative method) from measured raw data. The calculated absorption values exist in the form of voxels. These voxels are expressed in medical imaging by gray-scale values.

Other operation and control of the CT device also takes place using the computing unit 7 and the keyboard 9. The calculated data may be output via a monitor 8 or a printer (not shown). An image is generated from gray-scale values for representation on the monitor 8 or for the generation of images for the archiving (e.g., PACS). This corresponds to an image of voxels on pixels, from which the image is composed. Corresponding methods are referred to as volume rendering. A frequently used method for volume rendering is ray casting or pixel calculation using simulated beams, which is illustrated below with the aid of FIG. 3.

As shown in FIG. 3, beams from a virtual eye 201 are sent through each pixel of a virtual image plane 202 in the case of ray casting. Points of these beams are scanned within the volume or the object 204 at discrete positions (e.g., first position 204). A plurality of scanning values is combined to form a final pixel color or a final pixel.

An embodiment of a procedure during pixel calculation with multi resolution is shown in FIG. 4. A scanning value is calculated for scanning points i=1 . . . n at locations (xᵢ,yᵢ,zᵢ). The tile including the location (xᵢ,yᵢ,zᵢ) and/or the associated leaves are identified (e.g., by crossing the tree) for the respective location (xᵢ,yᵢ,zᵢ) using a tree structure used for multi resolution. A brick BRICKᵢ is or will be assigned if necessary to the tiles. This brick BRICKᵢ includes voxel values for the tile that correspond to a resolution (e.g., level of detail (LOD)) defined for the position of the tile. The corresponding resolution LODᵢ is determined with the aid of the leaf and/or the brick. According to this resolution, a transfer function TFᵢ is defined for the calculation of the scanning value. A gray-scale value GVᵢ for the scanning point (xᵢ,yᵢ,zᵢ) is calculated from the values of the brick. This is mapped onto a RGBA value RGBAᵢ by the transfer function TFᵢ. Lighting may still be taken into account within the scope of an illumination model. The RGBA value is combined with the previously calculated RGBA values within the course of an Alpha Compositing (e.g., RGBAᵢ is linked with Com(RGBA₁, . . . ,RGBAᵢ₋₁) to Com(RGBA₁, . . . ,RGBAᵢ)), where the mapping “Com” designates the overlaying of the RBBA values cited as argument. The pixel calculation is concluded if i=n (e.g., all scanning points of the corresponding beam were taken into account, or the calculation for a value n₁<is interrupted because due to masking, further scanning points would no longer contribute further). The pixel is then essentially expressed by Com(RGBA₁, . . . ,RGBAₙ) or Com(RGBA₁, . . . ,RGBAₙ₁).

The selection of the transfer function TFᵢ may have no influence on the calculated ALPHA value or the transparency value. In other words, the corresponding resolution LODᵢ determines the tinting.

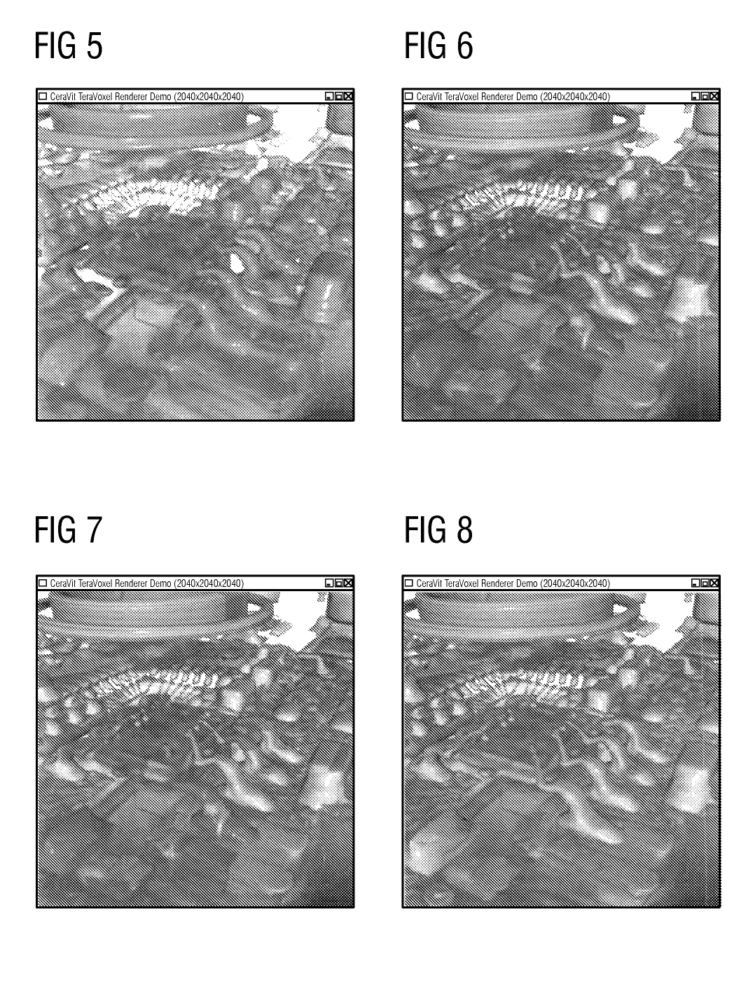

An image calculated with an increasingly higher resolution is shown in FIGS. 5-8. The method used initially calculates an image with a lower data resolution and/or quality and gradually implements a recalculation with the highest quality for the pixel still not present with the highest quality. The image is updated continuously. For a method of this type, two different colors or two different transfer functions TF that produce different colors (e.g., green and blue) may be used. One of the transfer functions is used if the resolution does not correspond to the highest resolution or a desired target resolution. The other transfer function is used in the target resolution. As apparent from the Figures, the user may trace which part of the image was calculated with the target resolution at which point in time. During the image interpretation and/or image analysis, the user may thus initially concentrate on the parts that already have the best resolution. A more focused and more efficient operation is thus enabled.

The invention is not restricted to the example described above. For example, other methods may be used for volume rendering purposes. Another optical identifier of the resolution used for calculating pixels as a change in the tinting may also be provided. A combination of different optical identifying features (e.g., tinting and shading) may also be provided in order to render resolution information visible in the image.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for generating an image formed with pixels from volume data representing a volume with the aid of volume rendering with multi resolution, the method comprising:
implementing a calculation of a pixel of the image;
determining an item of information characterizing a resolution used during the pixel calculation; and
adjusting the pixel in accordance with this item of information.

2. The method as claimed in claim 1, wherein the adjusting is implemented during the course of the pixel calculation.

3. The method as claimed in claim 1, wherein the adjusting is implemented following the pixel calculation.

4. The method as claimed in claim 1, further comprising defining a target resolution,
wherein the adjusting is based on whether the calculation of the pixel was implemented with the target resolution.

5. The method as claimed in claim 4, further comprising recalculating pixels that were not calculated with the target resolution.

6. The method as claimed in claim 1, wherein the volume data is obtained from measured data.

7. The method as claimed in claim 1, wherein the adjusting comprises selecting a transfer function.

8. The method as claimed in claim 1, wherein the adjusting includes a tinting, a shading, a selection of a rendering mode, a selection of a modulation mode, or a combination thereof.

9. The method as claimed in claim 2, wherein the volume data is obtained from measured data.

10. The method as claimed in claim 3, wherein the volume data is obtained from measured data.

11. The method as claimed in claim 5, wherein the volume data is obtained from measured data.

12. The method as claimed in claim 2, wherein the adjusting comprises selecting a transfer function.

13. The method as claimed in claim 3, wherein the adjusting comprises selecting a transfer function.

14. The method as claimed in claim 5, wherein the adjusting comprises selecting a transfer function.

15. The method as claimed in claim 2, wherein the adjusting includes a tinting, a shading, a selection of a rendering mode, a selection of a modulation mode, or a combination thereof.

16. The method as claimed in claim 3, wherein the adjusting includes a tinting, a shading, a selection of a rendering mode, a selection of a modulation mode, or a combination thereof.

17. The method as claimed in claim 5, wherein the adjusting includes a tinting, a shading, a selection of a rendering mode, a selection of a modulation mode, or a combination thereof.

18. The method as claimed in claim 1, wherein the volume rendering comprises using ray casting, and
wherein the adjusting is performed per scanning value, per beam or per beam block.

19. An apparatus for generating an image formed with pixels from volume data representing a volume with the aid of volume rendering with multi resolution, the apparatus comprising:
a computing unit configured to:
implement a calculation of a pixel of the image;
determine an item of information characterizing resolution used during the pixel calculation; and
adjust the pixel in accordance with the item of information.

20. In a non-transitory computer readable storage medium having stored therein data representing instructions executable by a programmed processor for generating an image formed with pixels from volume data representing a volume with the aid of volume rendering with multi resolution, the instructions comprising.
implementing a calculation of a pixel of the image;
determining an item of information characterizing a resolution used during the pixel calculation; and
adjusting the pixel in accordance with this item of information
